(19) United States
(12) Patent Application Publication
(10) Pub. No.: US 2020/0048925 A1
(43) Pub. Date: Feb. 13, 2020

(54) HUNTING BLINDS AND ACCESSORIES FOR MOUNTING HUNTING BLINDS

(71) Applicant: Daniel Earl COOPER, Cottage Grove, TN (US)

(72) Inventor: Daniel Earl COOPER, Cottage Grove, TN (US)

(21) Appl. No.: 16/361,770

(22) Filed: Mar. 22, 2019

Related U.S. Application Data
(60) Provisional application No. 62/716,118, filed on Aug. 8, 2018.

(51) Int. Cl. E04H 15/00; A01M 31/02; E04H 15/28

(52) U.S. Cl. CPC E04H 15/001; E04H 15/28; A01M 31/025

(57) ABSTRACT

Hunting blinds and devices for attaching hunting blinds to secure structures are provided. A portable hunting blind, according to one implementation, includes a hub, a plurality of spokes extending outward from the hub, and a concealment cover supported by the plurality of spokes. The portable hunting blind further includes a central pole including an upper pole segment, a lower pole segment, and a joint connecting the upper pole segment with the lower pole segment. The upper pole segment is connected to the hub, and the lower pole segment has an end configured to contact a ground surface. The joint enables the lower pole segment to pivot with respect to the upper pole segment.

### CROSS-REFERENCE TO RELATED APPLICATION

This application claims the benefit of U.S. Provisional App. No. 62/716,118, filed Aug. 8, 2018.

### TECHNICAL FIELD

The present disclosure is generally directed to hunting blinds and more particularly is directed to portable hunting blinds and accessories that may be used for mounting portable hunting blinds.

### BACKGROUND

While hunting, it is normally desirable for a hunter to be concealed from view in order that the prey is not alerted to the hunter's presence. Hunting blinds are often used by hunters for this purpose of concealment. Some types of hunting blinds are freestanding structures that are placed on the ground, while other hunting blinds may be elevated above the ground and may, in some cases, be incorporated into tree stands.

Typically, hunting blinds are configured as simple structures, but may be rather bulky and difficult to move. Some hunting blinds may even be installed permanently in a location. However, since it may be desirable for a hunter to be able to change hunting locations, it may be difficult or nearly impossible for one or two hunters to move a large hunting blind from one location to another.

Therefore, there is a need to provide hunting blinds that may be used by hunters in any desired location. There is also a need for hunting blind systems that are easy to set up and tear down as well as easy to transport.

### SUMMARY

The present disclosure is generally directed to various hunting blinds and accessories and systems for supporting and mounting hunting blinds. The present application may be more specifically directed to hunting blinds that are portable and can be easily carried from one hunting location to another, which is an improvement over conventional hunting blinds that are very large and very difficult to move.

In one embodiment, a hunting blind is configured as a portable device including a hub, a plurality of spokes extending outward from the hub, and a concealment cover supported by the plurality of spokes. The hunting blind further includes a central pole including an upper pole segment, a lower pole segment, and a joint connecting the upper pole segment with the lower pole segment. The upper pole segment is connected to the hub, and the lower pole segment has an end configured to contact a ground surface. The joint enables the lower pole segment to pivot with respect to the upper pole segment.

According to another embodiment, an apparatus is provided for establishing a support for a hunting blind that may be connected to a tree or other vertical support. The apparatus in this embodiment comprises a first tubing piece and a support assembly. The support assembly includes a plate support tube connected to the first tubing piece, a plate connected to the plate support tube, and one or more strap loops connected to the plate support tube and plate. The apparatus further includes a top hook configured for removable connection with a hunting blind.

According to another embodiment, a freestanding hunting blind support is provided. The freestanding hunting blind support includes a pole having a top end and a bottom end, where the bottom end of the pole defines a stake configured to be pressed below a surface of the ground. The hunting blind support further includes a T-bar attached in a substantially perpendicular orientation with respect to the pole, the T-bar being configured to allow a user to press the stake into the ground. Also, the hunting blind support comprises a top hook attached to the top end of the pole, the top hook being configured for removable attachment with a hunting blind.

In accordance with yet another embodiment, a shooting frame may be mounted on a tripod configured to rest on a surface of the ground and may include top and bottom horizontal tubing pieces. The bottom horizontal tubing piece may be attached to the tripod, and the top horizontal tubing piece may be adapted as a shooting rail. The shooting frame further comprises a plurality of vertical tubing pieces connected to the top and bottom horizontal tubing pieces. The shooting frame may be connected with an adapter pole having a plurality of openings formed therethrough and a top hook connected to a top end of the adapter pole, wherein the top hook may be configured to support a hunting blind. The shooting frame is also configured with a plurality of U-bolts configured to connect the top and bottom horizontal tubing pieces to the adapter pole.

### BRIEF DESCRIPTION OF THE DRAWINGS

FIG. 1 is an inside view of a hunting blind according to various embodiments of the present disclosure.

FIG. 2 is an outside view of the hunting blind of FIG. 1.

FIG. 3 is partial side view of an end of one of the spokes shown in FIG. 1, according to one embodiment.

FIGS. 4A-4C are side views of the hunting blind of FIG. 1 shown is three different tilted arrangements, according to some embodiments of the present disclosure.

FIG. 5 is a front view of a hunting blind support device, according to various embodiments of the present disclosure.

FIG. 6 is a side view of the hunting blind support device of FIG. 5.

FIG. 7 is a top view of the hunting blind support device of FIG. 5.

FIG. 8 is a front view of a freestanding hunting blind support device, according to various embodiments of the present disclosure.

FIG. 9 is a front view of a shooting frame configured for attachment with a hunting blind support device, according to various embodiments of the present disclosure.

FIG. 10 is a partial side view showing the attachment of an adapter pole to the shooting frame of FIG. 9, according to one embodiment.

### DETAILED DESCRIPTION OF EMBODIMENTS

Hunting blinds are commonly used by hunters to provide concealment. Although conventional hunting blinds are typically installed in one fixed location, the hunting blinds described in the present disclosure include a benefit over these conventional hunting blinds in that they may be set up in any desired location. Specifically, the hunting blinds of the present disclosure may be portable.

Also, unlike traditional hunting blinds, the portable hunting blinds described herein are an improvement because they can be easily set up and can be easily taken down. In a collapsed state, the hunting blinds described herein can be easily carried from one location to another, allowing the hunter to establish any location as a hunting location.

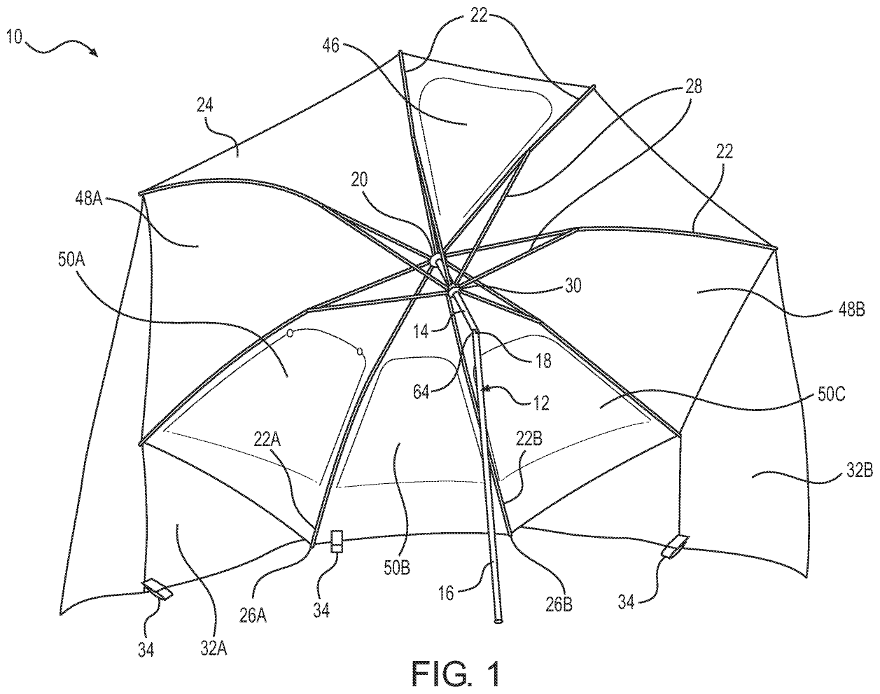

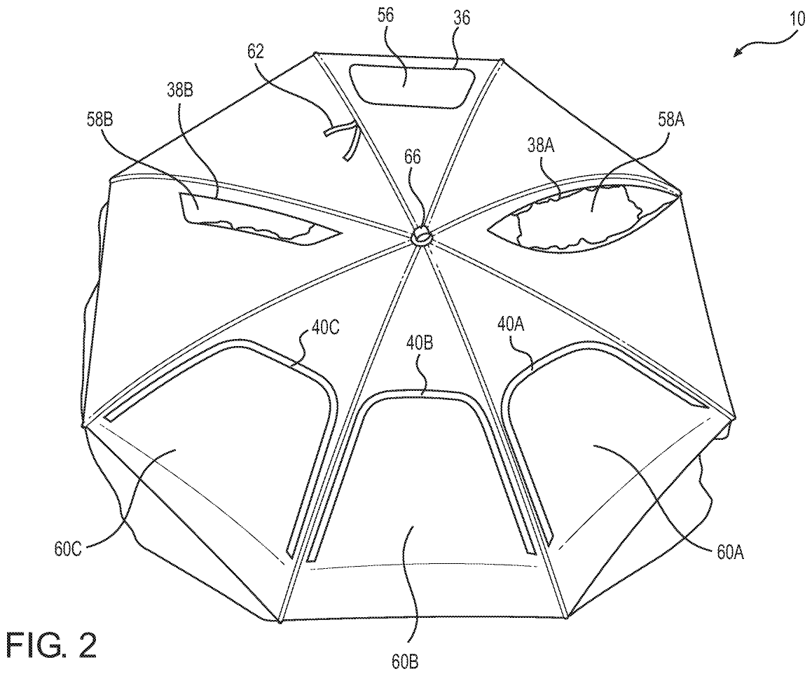

FIG. 1 is an inside view of an embodiment of a hunting blind 10 and FIG. 2 is an outside view of the hunting blind 10. The hunting blind 10, according to this embodiment, is configured to be placed on the ground (not shown). It may be noted from FIGS. 1 and 2 that the hunting blind 10 resembles an umbrella placed on its side.

As shown in FIG. 1, the hunting blind 10 includes a central pole 12 that is used to prop the hunting blind 10 on its side. The central pole 12 may comprise aluminum, light-weight steel, or other suitable material. The central pole 12 includes an upper part 14, a lower part 16, and a joint 18 that connects the upper part 14 with the lower part 16 and allows the upper part 14 and lower part 16 to pivot with respect to each other.

A top end of the upper part 14 of the central pole 12 is attached to a hub 20 and a bottom end of the upper part 14 is pivotably connected to the joint 18. A top end of the lower part 16 of the central pole 12 is pivotably connected to the joint 18 and a bottom end of the lower part 16 is configured to rest on top of a surface of the ground or may be inserted into the ground.

The hunting blind 10 also includes a plurality of spokes 22, which extend radially from the hub 20 in a plurality of directions. As illustrated in this embodiment, the hunting blind 10 includes eight spokes 22, but any other suitable number of spokes 22 may be included in alternative embodiments. In some embodiments, the spokes 22 may have substantially the same length and may comprise aluminum, light-weight steel, or other suitable material. First ends of the spokes 22 are pivotably connected to the hub 20 and second ends of the spokes 22 may be positioned in a somewhat circular pattern around a top portion of the central pole 14. A removable cover 24, or concealment cover, may be formed on or supported by the spokes 22. The cover 24 may be water-repellant and may include any suitable material that is light weight and durable.

When the hunting blind 10 is arranged at an angle and sits on the ground, as illustrated in FIGS. 1 and 2, the bottom ends of two of the lowermost spokes 22A, 22B may be configured to rest on the ground to allow the hunting blind to sit at an angle. Thus, the hunting blind 10 may be configured to rest on the ground while contacting the ground at the bottom end of the lower part 16 of the central pole 12 and at the bottom ends of the two lowermost spokes 22A, 22B. The bottom ends of these lowermost spokes 22A, 22B may include enlarged or reinforced caps 26A, 26B to protect the hunting blind 10 while sitting on the ground.

The hunting blind 10 also include arms 28, wherein each arm 28 corresponds to a respective spoke 22. Each arm 28 includes a first end that is pivotably attached to a collar 30 and a second end that is pivotably attached to a middle section of the respective spoke 22. When a user pushes the collar 30 upward toward the hub 20 in a manner similar to opening an umbrella, the spokes 22 extend outward to spread the cover 24 over a larger area. In FIGS. 1 and 2, the hunting blind 10 is shown in its extended state. To retract the hunting blind 10 in a manner similar to closing an umbrella, the upper part 14 and lower part 16 of the central pole 12 are aligned and the user pushes the collar 30 downward along the central pole 12 away from the hub 20. In some embodiments, the collar 30 may be pushed down the central pole 12 to a position below the joint 18.

When the hunting blind 10 is placed on the ground, the bottom end of the lower part 16 of the central pole 12 may rest on the ground. In some embodiments, the bottom end of the lower part 16 may include a stake that allows it to be driven into the ground. When driven in the ground, the lower part 16 may be oriented vertically, or close to a vertical orientation with respect to the ground, to allow the bottom end of the central pole 12 to be easily inserted into the ground.

The hunting blind 10 may further include one or more skirts 32A, 32B that can be permanently or temporarily attached to the cover 24. For example, one corner of first skirt 32A may be connected to a portion of the cover 24 adjacent to the first reinforced cap 26A at the end of the first lowermost spoke 22A. Also, one corner of the second skirt 32B may be connected to a portion of the cover 24 adjacent to the second reinforced cap 26B at the end of the second lowermost spoke 22B. When the hunting blind 10 is oriented at an angle and is resting on the ground, the skirts 32A, 32B are configured to provide additional coverage to one or both sides of the cover 24. In the extended condition, the cover 24 and skirts 32A, 32B together may form somewhat of a half-dome shape.

Bottom edges of the cover 24 and skirts 32A, 32B may include loops 34 sewn into the material of these components. The loops 34 may be used with stakes (e.g., tent pegs) to secure the bottom edges of the cover 24 and skirts 32 to the ground.

The hunting blind 10, according to some embodiments, may further include one or more windows in the cover 24. For example, the hunting blind 10 may include a top window 36 (shown in FIG. 2), side windows 38A, 38B, and bottom windows 40A, 40B, 40C. Also, one or more flaps may be attached to the cover 24 and may have a shape that corresponds to the windows 36, 38, 40. For example, the hunting blind 10 may include a top flap 46 (shown in FIG. 1) corresponding to the top window 36, side flaps 48A, 48B corresponding to respective side windows 38A, 38B, and bottom flaps 50A, 50B, 50C corresponding to respective bottom windows 40A, 40B, 40C. The flaps 46, 48, 50 are accessible from the inner side (FIG. 1) to allow a hunter stationed underneath or behind the hunting blind 10 to open or close the flaps 46, 48, 50.

The edges of the flaps 46, 48, 50 and corresponding windows 36, 38, 40 may include temporary attachment elements, such as zippers, hook and loop elements (e.g., Velcro), or other elements for allowing the flaps 46, 48, 50 to be opened or closed to cover or expose the windows 36, 38, 40. When closed, the flaps 46, 48, 50 cover the windows 36, 38, 40. When opened, the windows 36, 38, 40 are exposed. In the opened condition, a hunter can still be concealed behind the cover 24.

In some embodiments, the windows 36, 38, 40 may also include a mesh material, which may be connected to an outer side of the hunting blind 10. For example, the hunting blind 10 may include a top mesh piece 56 (see FIG. 2), side mesh pieces 58A, 58B, and bottom mesh pieces 60A, 60B, 60C, corresponding respectively to the top window 36, side windows 38A, 38B, and bottom windows 40A, 40B, 40C. The edges of the mesh pieces 56, 58, 60 and windows 36, 38, 40 may also include another set of temporary attachment elements (e.g., zippers, Velcro, etc.) to allow the mesh pieces 56, 58, 60 to be opened, closed, or removed. The mesh pieces 56, 58, 60 may be accessible by the user from an outer side (FIG. 2) of the hunting blind 10.

Zippers may be used for attaching the flaps 46, 48, 50 and mesh material pieces 56, 58, 60 to the edges of the windows 36, 38, 40. Each zipper may have a double zipping feature with two zipping/unzipping tabs. Also, the zipper tabs may be accessible from both the inner side (FIG. 1) position and outer side (FIG. 2) position.

In the embodiment shown in FIGS. 1 and 2, the hunting blind 10 includes six windows 36, 38, 40. Three bottom windows 40 are formed in the three lowest sections of the cover 24. Two side windows 38 are formed in the two middle sections of the cover 24. Also, the top window 36 may be formed in the upper section of the cover 24. Flaps 46, 48, 50 may be formed on the inner side of the cover 24 and the mesh material pieces 56, 58, 60 may be formed on the outer side of the cover 24.

In some embodiments, the inner surface of the cover 24 and/or skirts 32 may include pouches for holding keys, bird calls, and other small items.

The hunting blind 10 of FIGS. 1 and 2 may have the appearance of an oversized umbrella and may be large enough to concealing at least two hunters. In some embodiments, the cover 24 may include a camouflage pattern. Also, the outside of the cover 24, as shown in FIG. 2, may include brush ties 62 or other thin strips of material that can be used to tie branches, leaves, or other natural vegetation to the outside of the cover 24 for an added camouflage effect.

An outer layer of the cover 24 (as seen in FIG. 2) may include a camouflage pattern. An inner layer of the cover 24 (as seen in FIG. 1) may include polyurethane (PU) or other suitable material that is water-proof. Black PU material can eliminate shadow effects and may be helpful to hide the hunter and prevent visibility of the hunter from the other side. In some embodiments, the outer layer and inner layer of material may be permanently attached to each other, but in other embodiments, the outer and inner layers may be separate.

The central pole 12 is adjustable to allow for orienting the hunting blind 10 at different angles, which essentially lowers and raises the height of the windows. The joint 18 may include a push button 64, which the user can press to adjust the angle between the upper part 14 and lower part 16 of the central pole 12. In some embodiments, the joint 18 and push button 64 may allow the upper and lower parts 14, 16 of the central pole 12 to be arranged in one of three or more angle positions.

A top cap 66 as shown in FIG. 2 is connected to the hub 20 at the top of the central pole 12. The top cap 66 helps to keep the cover 24 in place. For example, the top cap 66 may have screw threads on an inside surface corresponding to screw threads on an outside surface of the hub 20.

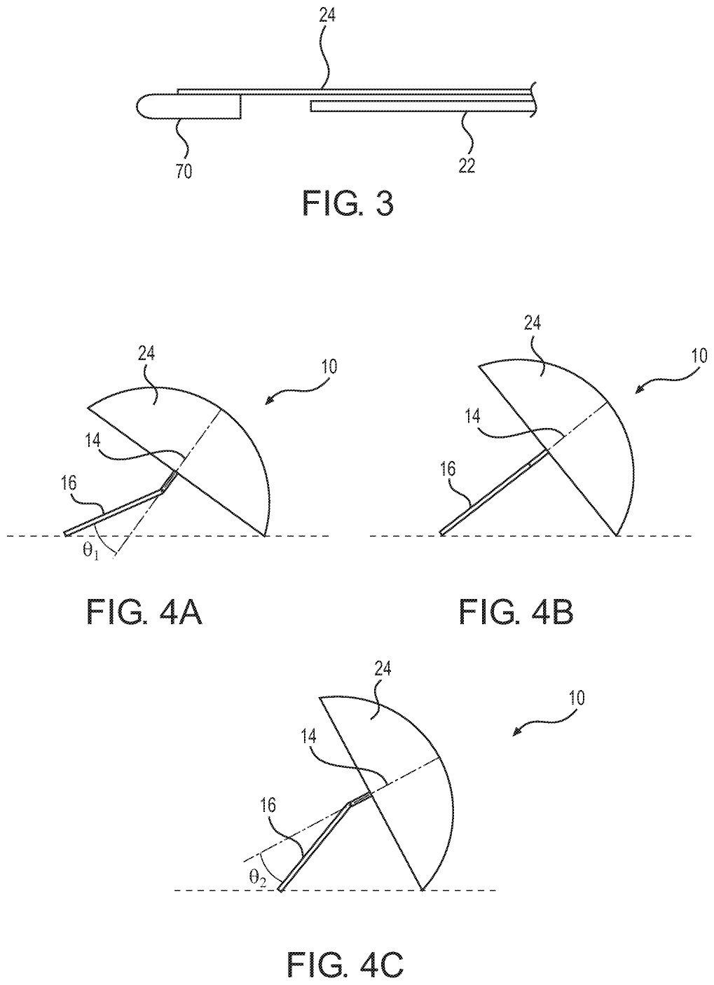

FIG. 3 is partial side view of an end of one of the spokes 22 of the hunting blind 10. According to one embodiment, end caps 70 may be connected to the cover 24 at locations corresponding to the positions of ends of the spokes 22. Each of the end caps 70 may include a bore hole extending partially therethrough, whereby the ends of the spokes 22 may be inserted into the bore holes. In some embodiments, the end caps 26A, 26B shown in FIG. 1 may be configured as reinforced caps that may include material that is stronger or larger than the other end caps 70 that may not necessarily be designed for resting on the ground.

To attach the cover 24 to the spokes, the end caps 70, 26 are connected to the edges of the cover 24 and the ends of the spokes 22 are inserted into the end caps 70, 26. To remove the cover 24 from the spokes, the end of the spokes 22 can be removed from the end caps 70, 26 by sliding the spoke 22 out of the bore holes of the end caps 70, 26.

Inner seams between the segments of the cover 24 may include Velcro or other attachment elements for attaching an inner portion of the cover 24 to middle sections of the spokes 22. When the cover 24 is to be removed, the attachment elements can be separated to allow the cover 24 to be disconnected from the spokes 22.

The top cap 66 may also be removable from the hub 20 of the central pole 12 to allow the cover 24 to be removed. The top cap 66 may be formed with screw threads corresponding to screw threads of the hub 20. In other embodiments, the top cap 66 may form a snap connection with the hub 20 or may be formed using other removable attachment elements.

The cover may be removed by the following method. The step of removal may include 1) removing the top cap 66, 2) disengaging the ends of the spokes 22 from the end caps 70, 26A, 26B, and 3) loosening the Velcro supports on the inner surface of the cover 24.

At this point, the cover 24 may be removed and replaced with another cover if needed. For example, if the cover 24 is damaged, the user can remove the old one and replace it with a new one. Also, it may be desirable for a hunter to own more than one cover having different camouflage patterns for blending into different environments. For example, camouflage patterns may include a winter/snow pattern for hunting in the snow, a marsh pattern for duck hunting, a leafy pattern for turkey hunting, a hardwood pattern for deer hunting, just to name a few.

During transport, the hunting blind 10 can be collapsed into a small volume. For example, the user may slide the collar 30 down the central pole 12 away from the hub 20, causing the arms 28 to pull the spokes 22 close to the central pole 12. In some embodiments, a carry bag may be used for carrying the hunting blind 10 when it is collapsed down to a portable size.

FIGS. 4A-4C are side views of the hunting blind 10 shown in different tilted arrangements. According to some embodiments, the hunting blind 10 may be configured in one of three tilted arrangements, although another number (e.g., 2, 4, 5, 6, 7, etc.) of positions may be possible in other embodiments.

The joint 18 may be specifically configured so as to allow the upper and lower parts 14, 16 of the central pole 12 to be aligned (see FIG. 4B) along an axis or to pivot at various angles θ₁ and θ₂ (see FIGS. 4A, 4C). In one embodiment, the angle θ₁ may be equal to the angle θ₂. The joint 18 may include the push button 64 that, when pressed by the user, allows the upper and lower parts 14, 16 to pivot with respect to each other.

A first position, as shown in FIG. 4A, may include an angle θ₁ where the lower part 16 is pivoted in a first direction away from the ground when the ends of the two lowermost spokes 22A, 22B are resting on the ground. A first pivot angle θ₁ (about 30 degrees) may be formed between the lower part 16 and a central axis defined by the upper part 14 of the central pole 12.

A second position may be a condition where the upper and lower parts 14, 16 of the central pole 12 are aligned with each other along the central axis. In this arrangement, the lower part 14 is oriented at 0 degrees, as shown in FIG. 4B.

A third position, as shown in FIG. 4C, may include an angle where the lower part 16 is pivoted in a second direction that is opposite of the first direction of FIG. 4A (e.g., toward the ground). A second pivot angle θ₂ (about 30 degrees) may be formed between the lower part 16 and the central axis in the third position shown in FIG. 4C.

With the various positions illustrated in FIGS. 4A-4C, the upper part 14 of the central pole 12 (and thus the cover 24) may be oriented at various angles with respect to the ground. With the cover 24 tilted at a small angle with respect to the ground (FIG. 4A), which, for example, may be about 30 degrees, a hunter may wish to lie on his/her stomach and fire through a bottom window 40. With the cover 24 tilted at a medium angle with respect to the ground (FIG. 4B), which, for example, may be about 45 degrees, a hunter may wish to sit on the ground and fire through a side window 38. With the cover 24 tilted at a high angle with respect to the ground (FIG. 4C), which, for example, may be about 60 degrees, a hunter may wish to sit on a stool and fire through the top window 36 and/or one of the side windows 38A, 38B.

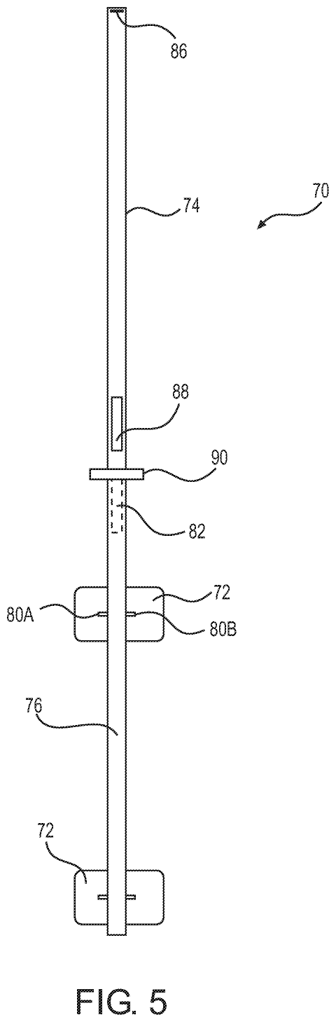

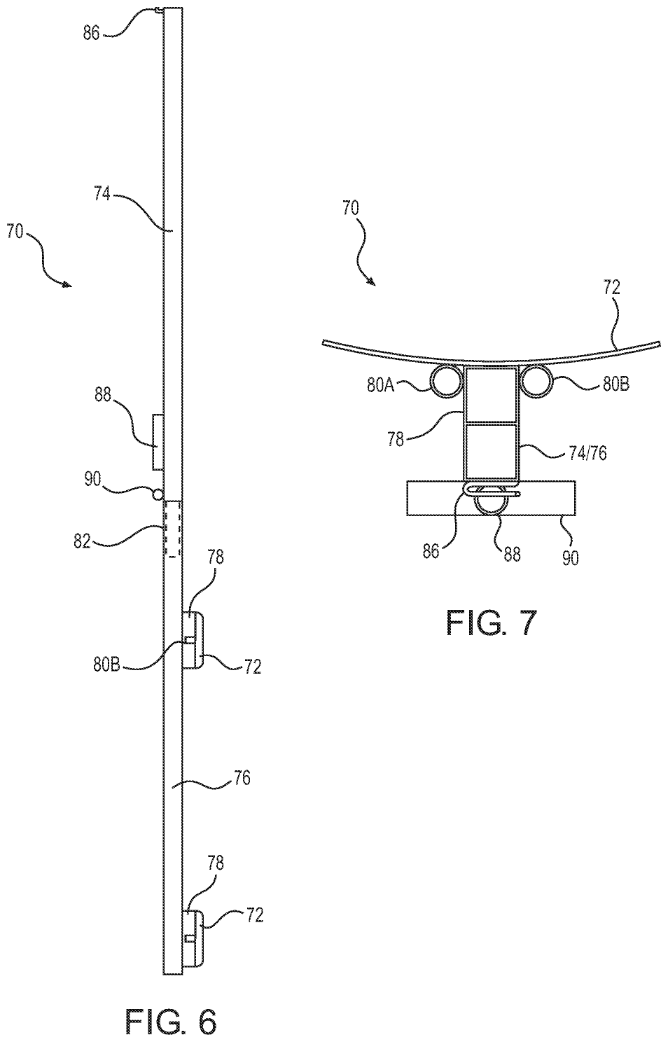

FIG. 5 is a front view of an embodiment of a hunting blind support device 70, wherein the hunting blind support device 70 is configured to be attached to a tree and is configured to support a top of a hunting blind, such as a top part of hunting blind 10 described with respect to FIGS. 1-4. FIG. 6 is a side view of the hunting blind support device 70 and FIG. 7 is a top view of the hunting blind support device 70. For example, the hunting blind support device 70 may be used when a hunter is positioned on a tree stand and intends to secure a hunting blind (e.g., hunting blind 10) while the hunting blind rests on the tree stand or against a tree. The hunting blind support device 70 may be useful in windy conditions to prevent the hunting blind from being blown away by the wind.

The hunting blind support device 70 comprises one or more flat plates 72, which may be contoured (as shown in FIG. 7) to match the outer surface of a tree on which the apparatus may be supported. The hunting blind support device 70 also includes tubing, such as one-inch square tubing having a square cross-section as shown in the top view of FIG. 7. The tubing may include an upper tubing piece 74 and a lower tubing piece 76. Each of the flat plates 72 may be connected to the lower tubing piece 76 by a plate support tube 78. Left and right strap loops 80A, 80B are connected to the left and right sides of the plate support tubes 78 and may further be connected to the flat plates 72. The hunting blind support device 70 may be made of any suitable material, such as steel. Straps, not shown, may be inserted through the strap loops 80A, 80B. In use, the straps may be wrapped around a tree and the ends of the straps may be connected together by buckles, hook and loop elements, or other attachment elements (not shown), or in other embodiments, the ends of the straps may be tied together.

A frame, which may be made of light-weight metal, steel, or other suitable material, may include the tubing 74, 76 and may be attached to the flat plates 72, via the plate support tube 78, such that when the flat plates 72 are placed against a tree and the straps are wrapped around the tree and secured through the strap loops 80A, 80B, the frame is supported in a generally vertical position substantially in line with the tree. The frame comprises the lower tubing piece 76 and the upper tubing piece 74, where a bottom end of the upper tubing piece 74 may be inserted into a top end of the lower tubing piece 76. A spring-loaded push button 82 may be used to hold the upper tubing piece 74 within the lower tubing piece 76 and may be pushed to allow the upper tubing piece 74 to be released from the lower tubing piece 76 when the user wishes to take the apparatus apart. When assembling the apparatus, the user may slide the upper tubing piece 74 into an opening in the top of the lower tubing piece 76.

The hunting blind support device 70 further includes a horizontal rod receiver 90 that may be attached to a bottom portion of the upper tubing piece 74. At the top of the apparatus, the upper tubing piece 74 also includes a top hook 86, loop, or other suitable element. The top hook 86 may be tethered to a top portion of a hunting blind to keep the hunting blind secure on the tree stand.

A bottom portion of the upper tubing piece 74 may further include a bow holder 88 oriented in an axial direction parallel to an axis of the square tubing pieces 74, 76. The bow holder 88 may have a circular cross-section and may be configured to support a hunting bow.

When the hunting blind support device 70 is connected in its extended state and is attached to the tree, the apparatus can be used to secure a hunting blind (not shown). The hunting blind used with this apparatus may include a horizontal tube that is inserted into or secured to the horizontal rod receiver 90. Then, a top portion of the hunting blind can be secured to the top hook 86 (or other element) that is connected to the top of the upper tubing 74. For example, a strap may be used to connect a hook, loop, or other connection device on a top portion of the hunting blind to the top hook 86 at the top of the apparatus 70.

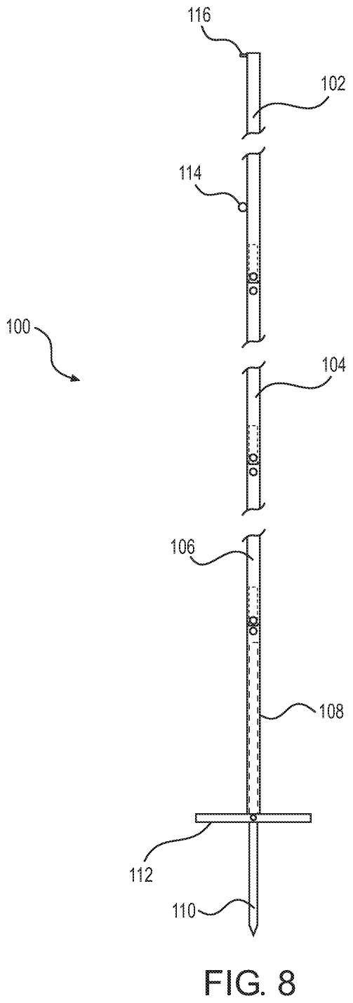

FIG. 8 is a front view showing an embodiment of a freestanding hunting blind support device 100, which may be used for securing hunting blinds that are positioned on the ground. Tube sections 102, 104, 106, 108 form an adapter pole that can be assembled by inserting a small end of one section with a larger end of an adjacent section. The lowest tube section 108 may include a ground stake 110. A T-bar 112 may be bolted to the tube section 108 near the bottom end of the adapter pole. The user can insert the adapter pole into the ground by stepping on the T-bar 112 to press the stake 110 into the ground. If the ground is hard, the user can use the adapter pole as a ram to drive the ground stake 110 into the ground.

With the adapter pole installed in the ground in a vertical orientation, a hunting blind can be hung from the top of the adapter pole. The hunting blind can be hung on the adapter pole by inserting curtain rods of the hunting blind into a rod receiver 114 connected to the top tube section 102 of the freestanding hunting blind support device 100. The hunting blind may be installed by hanging a top roof strap of the hunting blind on a top hook 116 of the support device 100.

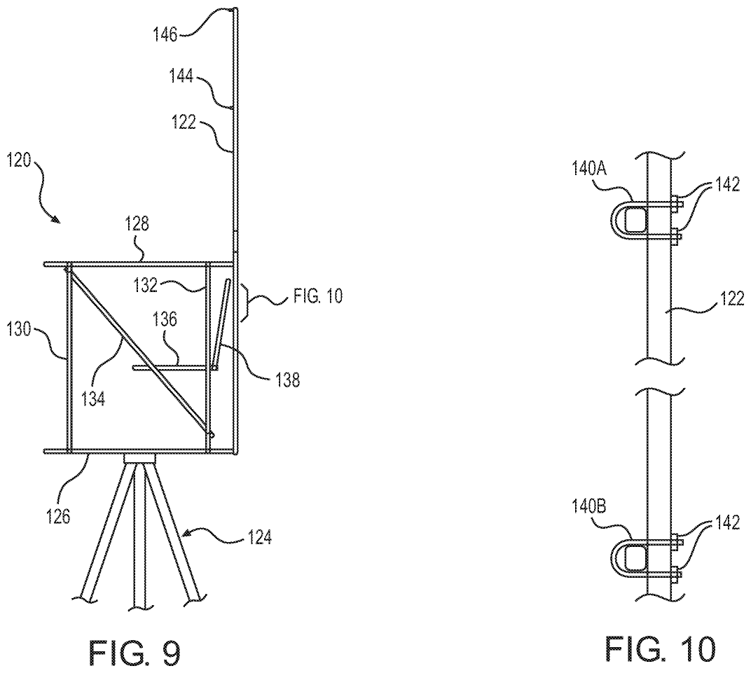

FIG. 9 is a front view of an embodiment of a shooting frame 120, which is configured to be attached with a hunting blind support device 122. Also, FIG. 10 is a partial side view of the shooting frame 120 showing a connection of the shooting frame 120 with the hunting blind support device 122 or adapter pole. In this embodiment, the hunting blind support device 122 can be attached to the shooting frame 120, which in turn is supported by a tripod 124. When used with the tripod 124 and shooting frame 120, as shown in FIG. 9, the adapter pole 122 can be configured differently than the adapter pole 100 of FIG. 8. For instance, in the embodiment of FIGS. 9 and 10, the T-bar 112 and ground stake 110 are omitted.

The shooting frame 120 may include a lower platform rail 126 and an upper shooting rail 128, which are horizontal rails. Vertical support rails 130, 132 are connected between the rails 126, 128. A diagonal rail 134 may be connected diagonally between a top portion of the first vertical support rail 130 and a bottom portion of the second vertical support rail 132 to maintain a rectangular shape of the frame 120 when in its extended condition. The diagonal rail 134 may be removed, allowing the shooting frame 120 to be folded into a compact arrangement. Additional rails 136, 138 may be attached to the shooting frame 120 to provide additional shooting platforms.

As shown in FIG. 10, the hunting blind support device 122, or adapter pole, can be attached to the horizontal rails 126, 128 of the shooting frame 120 using U-bolts 140A, 140B and respective nuts 142. A first U-bolt 140A can be inserted around an end portion of the upper shooting rail 128 and through openings in the adapter pole 122, and then nuts 142 can be used to fasten the adapter pole 122 to the shooting rail 128. A second U-bolt 140B can be inserted around an end portion of the lower platform rail 126 and through openings in the adapter pole 122, and then nuts 142 can be used to fasten the adapter pole 122 to the platform rail 126. Multiple sets of openings can be provided in the adapter pole 122 to allow the adapter pole 122 to be attached to the shooting frame 120 at a variety of different heights.

Once the adapter pole 122 is attached to the shooting frame 120, as shown in FIG. 9, a hunting blind can be secured to the adapter pole 112 by inserting the curtain rods of the hunting blind into a rod receiver 144 and hanging the top roof strap of the hunting blind on a top hook 146.

In one embodiment, a freestanding hunting blind support comprising: a pole having a top end and a bottom end, the bottom end of the pole defining a stake configured to be pressed below a surface of the ground;

a T-bar attached in a substantially perpendicular orientation with respect to the pole, the T-bar configured to allow a user to press the stake into the ground; and

a top hook attached to the top end of the pole, the top hook configured for removable attachment with a hunting blind.

In another embodiment, the freestanding hunting blind support of the embodiment above, may further comprise at least one of a bow receiver and a rod receiver.

These and other alternative embodiments of hunting blinds and accessories for setting up hunting blinds are described above. It should be understand that various alternatives may be conceived from an understanding of the present disclosure. The embodiments are not limited to any particular hunting blinds or accessories, except as defined in the following claims.

What is claimed is:

1. A portable hunting blind comprising:
a hub;
a plurality of spokes extending outward from the hub;
a concealment cover supported by the plurality of spokes;
a central pole including an upper part, a lower part, and a joint connecting the upper part with the lower part, the upper part connected to the hub, and the lower part having an end configured to contact a ground surface;
wherein the joint enables the lower part to pivot with respect to the upper part.

2. The portable hunting blind of claim 1, wherein the joint enables the lower part to lock in place at one of three tilted positions including a downward tilted position, an aligned position, and an upward tilted position.

3. The portable hunting blind of claim 2, wherein the three tilted positions allow the portable hunting blind to be arranged at three angles with respect to the ground surface.

4. The portable hunting blind of claim 1, wherein ends of two bottom spokes of the plurality of spokes are configured to rest on the ground surface, the joint enabling the lower part to pivot towards and away from the two bottom spokes.

5. The portable hunting blind of claim 4, further comprising skirts, wherein each skirt is connected to the end of one of the two bottom spokes and ends of at least one additional spoke.

6. The portable hunting blind of claim 1, further comprising a collar connected to a plurality of arms, each arm extending from the collar to a middle portion of a respective spoke, the collar configured to move along the upper pole segment to arrange the portable hunting blind between a collapsed condition and an extended condition.

7. The portable hunting blind of claim 1, further comprising a plurality of windows formed in the concealment cover and a plurality of corresponding flaps configured to temporarily cover the respective windows.

8. The portable hunting blind of claim 7, further comprising a mesh material arranged in at least one of the plurality of windows.

9. The portable hunting blind of claim 1, further comprising one or more brush ties connected to an outside surface of the concealment cover, wherein the one or more brush ties are configured to hold plant and tree materials.

10. The portable hunting blind of claim 1, further comprising a top cap configured to be connected to the hub and further configured to contain the concealment cover on the hub.

11. The portable hunting blind of claim 1, further comprising a plurality of end caps connected to the concealment cover, each end cap configured for removable attachment with an end of a corresponding spoke.

12. An apparatus for establishing a support for a hunting blind, the apparatus comprising:
a first tubing piece;
a support assembly including a plate support tube connected to the first tubing piece, a plate connected to the plate support tube, and one or more strap loops connected to the plate support tube and plate; and
a top hook configured for removable connection with a hunting blind.

13. The apparatus of claim 12, further comprising a second tubing piece having an insert configured for removable connection with the first tubing piece.

14. The apparatus of claim 13, wherein the top hook is attached to a top portion of the second tubing piece.

15. The apparatus of claim 13, wherein the second tubing piece includes at least one of a bow receiver and a rod receiver.

16. The apparatus of claim 12, further comprising a strap inserted through the one or more strap loops and configured to wrap around a vertical support structure.

17. A shooting frame comprising:
top and bottom horizontal tubing pieces, the bottom horizontal tubing piece attached to a support structure for supporting the shooting frame above the ground, the top horizontal tubing piece adapted as a shooting rail;
a plurality of vertical tubing pieces connected to the top and bottom horizontal tubing pieces; and
a plurality of U-bolts;
wherein the shooting frame is configured to support an adapter pole having a plurality of openings formed therethrough such that a top hook connected to a top end of the adapter pole is configured to support a hunting blind; and
wherein the plurality of U-bolts are configured to connect the top and bottom horizontal tubing pieces to the adapter pole.

18. The shooting frame of claim 17, wherein ends of the U-bolts are inserted through the openings in the adapter pole and secured by nuts.
